(19) United States
(12) Patent Application Publication
(10) Pub. No.: US 2004/0207311 A1
(43) Pub. Date: Oct. 21, 2004

(54) White light emitting device

(76) Inventor: Jung-Pin Cheng, Taipei (TW)

Correspondence Address: Jung-Pin Cheng, P.O. Box No. 6-57, Junghe, Taipei, 235, TW

(21) Appl. No.: 10/418,270

(22) Filed: Apr. 18, 2003

(51) Int. Cl. H01J 1/62; H01J 63/04

(52) U.S. Cl. 313/499

(57) ABSTRACT

A white light emitting device includes a photosemiconductor functioning as a light source of blue light, and a fluorescent layer encapsulated and connected to the photosemiconductor. The characteristics thereof are that the fluorescent layer is formed by mixing red and green fluorescent with transparent glue, wherein the red fluorescent emits light having a spectrum (wavelength) different from that of the blue light after being excited by the blue light, and the green fluorescent emits light having a spectrum (wavelength) different from that of the blue light after being excited by the blue light. White light is then formed by blending the two distinct spectra (wavelengths) with a portion of unexcited blue light.

### BACKGROUND OF THE INVENTION

(a) Field of the Invention

The invention relates to a white light emitting device, and more particularly, to a white light emitting diode (LED) device.

(b) Description of the Prior Art

Referring to a prototypic example of a white light LED of a prior art disclosed by Taiwan Patent Publication No. 385063, “New White Light LED”, wherein white light is generated and displayed by exciting a coating layer formed from mixing red, green and blue (R, G, B) fluorescent with transparent glue using an ultraviolet photosemiconductor as a light source.

However, in the above type of light emitting device, the light source thereof is provided by ultraviolet light, which causes damages in structure of epoxy extensively used at the present time, and therefore, “white light” is attenuated at the end with unsatisfactory light intensity. Above all, the coating layer in the prior invention is a mixture of red, green and blue fluorescent powder, and a shortcoming of the invention is incurred for that the ratio and manufacturing process of the three fluorescent are hard to control.

In the Taiwan Patent Publication No. 383508 disclosing a “Light Emitting Device and Display Device”, a photoluminescence fluorescent body is a cerium doped garnet photoluminescence fluorescent body including at least one element from Y, La, Gd and Sm, and at least one element from Al, Ga and In.

However, a cerium doped garnet fluorescent body is in fact a yellow fluorescent body, wherein a semiconductor light emitting element made of gallium nitrides capable of emitting blue light of short wavelengths acts as a light source. The blue light emitted by this light source excites a yellow fluorescent layer thereof so as to produce and display white light of different wavelengths. However, because light of single wavelength thereof tends to mix with a portion of unexcited blue light, color rendering thereof becomes unsatisfactory; that is, the white light is distorted and is considered as impure. The reason behind the above phenomenon is due to the lack of spectrum of red light.

Hence, it is a vital task of the invention as how to invent a white light emitting device capable of providing white light having strong white light intensity and purity.

### SUMMARY OF THE INVENTION

Therefore, the object of the invention is to provide a white light emitting device, wherein a blue light emitting diode functions as a light source thereof for exciting a fluorescent layer having a mixture of red (or reddish orange) and green fluorescents, so as to enable the fluorescent layer change a wavelength of the blue light to further generate light having different spectra from the blue light, thereby producing and displaying pure white light having stronger light intensity as well as minimal light attenuation to the eye.

### BRIEF DESCRIPTION OF THE DRAWINGS

FIG. 1 shows a longitudinal sectional view according to the invention.

FIG. 2A shows another longitudinal sectional view according to the invention.

FIG. 2B shows yet another longitudinal sectional view according to the invention.

FIG. 3 shows a longitudinal sectional view illustrating the invention being adhered to a reflecting cover.

FIG. 4 shows a longitudinal sectional view illustrating another embodiment according to the invention being adhered to a reflecting cover.

### DETAILED DESCRIPTION OF THE PREFERRED EMBODIMENTS

To achieve the aforesaid object, characteristics of the invention shall be described with the accompanying drawings hereunder.

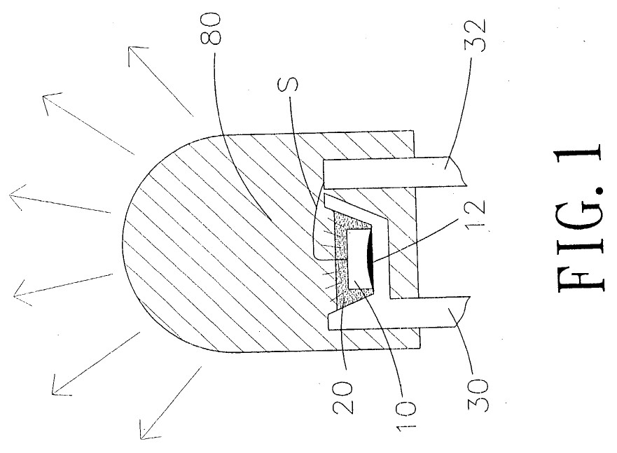

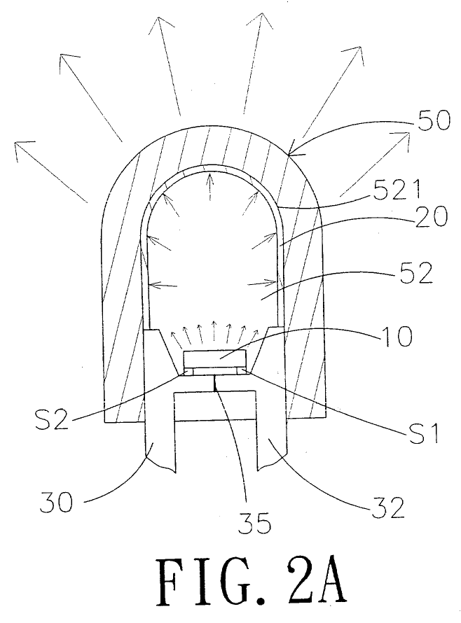

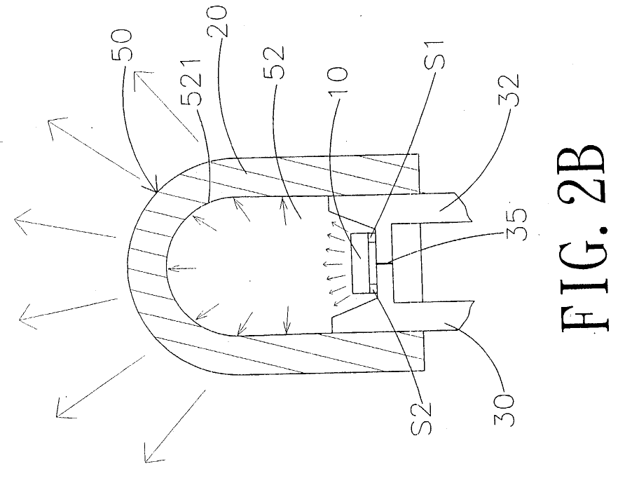

Referring to FIGS. 1 and 2, the invention comprises:

a photosemiconductor 10 as a light source of blue light;

a fluorescent layer 20 encapsulated and connected to the photosemiconductor 10; and

the characteristics thereof are that the fluorescent layer 20 is formed by mixing red and green fluorescent with transparent glue; the red fluorescent in the fluorescent layer 20 is excited by the blue light to further release emitted light having a spectrum (wavelength) different from that of the blue light; the green fluorescent therein is excited by the blue light to further release emitted light having a spectrum (wavelength) different from that of the blue light; and white light is produced by blending the two distinct spectra with a portion of unexcited blue light.

According to the aforesaid primary characteristic, wherein the red fluorescent is europium doped yttrium aluminum garnet (YAG: Eu), and the green fluorescent is europium doped strontium gallium sulfide (SrGa2S4: Eu). Also, the red fluorescent has an emitted light spectrum (wavelength) of 620 nm after being excited by the blue light source, the green fluorescent has an emitted light spectrum of 520 nm, and the blue light has a light emitting spectrum between 430 and 480 nm.

According to the aforesaid primary characteristic, wherein the red fluorescent powder may be replaced by reddish orange fluorescent, and the reddish orange fluorescent may be cerium doped yttrium aluminum garnet (YAG: Ce) that has an emitted light spectrum of 590 nm after being excited by the blue light source.

According to the aforesaid primary characteristic, wherein the fluorescent layer 20 may encapsulate and seal the photosemiconductor 10 as granule-like structures as shown in FIG. 1.

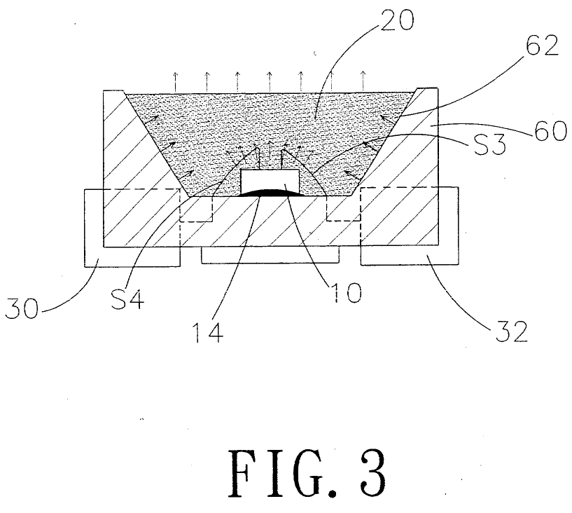

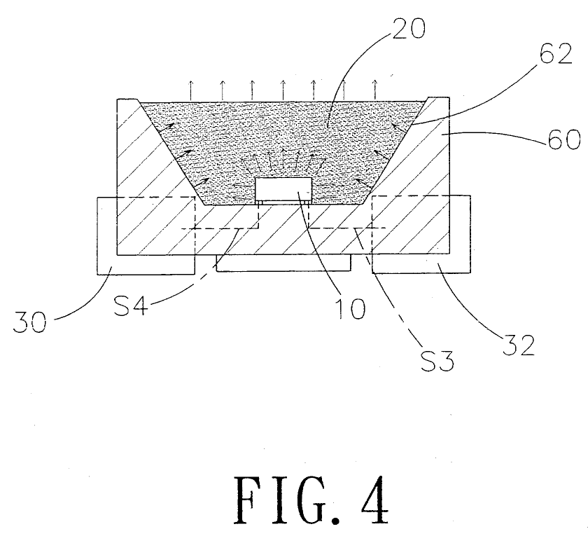

According to the aforesaid primary characteristic, wherein the photosemiconductor 10 and the fluorescent layer 20 may filled and paved at an upper breach 62 of a reflecting cover 60, and inner walls of the upper breach 62 form light reflecting planes as shown in FIGS. 3 and 4.

Another white light emitting device (as shown in FIG. 2A) provided by the invention comprises:

a photosemiconductor 10 as a light source of blue light; and

the characteristics thereof are that a provided cap cover 50 having a recess 52 at the interior thereof is a formed integral with transparent glue 80, wherein inner wall surfaces 521 of the recess 52 are applied with a film of fluorescent layer 20 formed by mixing red (or reddish orange) and green fluorescent and the transparent glue 80, and the cap cover 50 may by accommodated on top of the photosemiconductor 10.

According to the white light emitting device of the aforesaid secondary characteristic, wherein the cap cover 50 may be a formed integral from mixing red or reddish orange and green fluorescent with the transparent glue 80, so as to have the cap cover 50 directly function as a fluorescent layer 20 as shown in FIG. 2B.

### EXAMPLES

1. Referring to FIG. 1, the device according to the invention regards the photosemiconductor 10 as a center thereof, and a bottom of the photosemiconductor 10 is a conductor body connected to a left wire guiding stand 30. The fluorescent layer 20 is encapsulated and sealed on the photosemiconductor 10, wherein a lead S is penetrated through to go above the photosemiconductor 10 and is connected to a right wire guiding stand 32 so as to form an electric loop. Wherein, the transparent glue 80 encapsulates the photosemiconductor 10, the fluorescent layer 20, and upper portions of the left and right wire guiding stands 30 and 32 for further forming granule-like structures. The photosemiconductor 10 is preferably made of semiconductors from nitride compounds capable of emitting blue light for acting as a light source thereof; and the fluorescent layer 20 is formed by mixing red and green fluorescent powder with transparent glue using an appropriate ratio, so that when the photosemiconductor 10 emits blue light having peak wavelengths between 430 to 480 nm, the red fluorescent made of YAG: Eu in the fluorescent layer 20 changes the wavelengths of the blue light and emits a spectrum having a peak wavelength of 620 nm after being excited by the blue light, and the green fluorescent made of SrGa2S4: Eu changes the wavelengths of the blue light and emits a spectrum having a peak wavelength of 520 nm after being excited by the blue light. As a result, the red and green fluorescent absorb a portion of wavelengths of the blue light and change the wavelengths of the blue light of 470 nm to further produce light having two distinct wavelengths (620 nm and 520 nm) that are different from that of the blue light. The light having two distinct wavelengths plus the portion of unexcited blue light form blended light having three distinct wavelengths, and this light is defined as white light when being observed by a naked eye. The white light generated is not a result of mixture using an ultraviolet light source, and therefore the pure white light obtained has strong light intensity and minimal light attenuation. In addition, light of three colors (R, G, B) are mixed to produce white light so as to acquire a good color rendering thereof.

2. Referring to FIG. 2A, an interior of the cap cover 50 is provided with the round recess 52 having wall surfaces 521 applied or coated with a film of fluorescent layer 20, and the cap cover 50 is accommodated on the left and right wire guiding stands 30 and 32 of the photosemiconductor 10. Using the above structure, when the photosemiconductor 10 emits blue light to excite red and green fluorescent materials in the fluorescent layer 20, light having two distinct wavelengths is produced and transmitted through the transparent cap cover 50. A room in the round recess 52 is vacuum, positive and negative conducting pins S1 and S2 of the photosemiconductor 10 are welded onto the left and right wire guiding stands 30 and 32, respectively, the left and right wire guiding stands 30 and 32 are separated using an insulating element 35, and thus forming an electric loop. Referring to FIG. 2B, the cap cover 50 shown is a stamped integral with the fluorescent layer 20, and hence the cap cover 50 also functions as the fluorescent layer 20; that is, the cap cover 50 is also capable of emitting light having two distinct wavelengths. Referring to FIG. 3, a reflecting cover 60 is provided as a base thereof, the fluorescent layer 20 is filled and paved at the upper breach 62, a bottom of a photosemiconductor 10 is fixed to a bottom of the upper breach 62 using insulation glue 14, leads S3 and S4 are connected to the left and right wire guiding stands 30 and 32, respectively, so as to form an electric loop. The blue light emitted from the photosemiconductor 10 and the red and green light emitted from the glue light and the fluorescent layer 20 may all reflect out of the upper breach 62 through an inner walls of the upper breach 62, such that white light is displayed on the fluorescent layer 20. Referring to FIG. 4, the functions and techniques of the reflecting cover 60 combined with the fluorescent layer 20 and the photosemiconductor 10 are the same as those in FIG. 3, except that the leads S3 and S4 of the photosemiconductor 10 are penetrated out from the bottom to connect to the left and right wire guiding stands 30 and 32, respectively, so as to form an electric loop.

3. According to the invention, the red fluorescent in the fluorescent layer 20 may be replaced by reddish orange fluorescent made of cerium doped yttrium aluminum garnet (YAG: Ce) having an excited light emitting spectrum of a peak wavelength of 590 nm. The fluorescent layer 20 may also be formed by mixing reddish orange fluorescent and green fluorescent with transparent glue. This fluorescent layer 20 similarly absorbs blue light emitted by the photosemiconductor 10 for further triggering and emitting light having two distinct wavelengths of 590 nm and 520 nm. As a result, “pure white” light is produced and displayed by blending the light having the two distinct wavelengths with a portion of unexcited blue light (wavelength of 470 nm).

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A white light emitting device comprising:
a photosemiconductor functioning as a light source of blue light;
a fluorescent layer encapsulated and connected to the photosemiconductor; and
the characteristics thereof being that the fluorescent layer is formed by mixing red and green fluorescent with transparent glue; wherein the red fluorescent powder emits light having a spectrum (wavelength) different from that of the blue light after being excited by the blue light, and the green fluorescent emits light having a spectrum (wavelength) different from that of the blue light after being excited by the blue light; and white light is formed by blending the two distinct spectra (wavelengths) with a portion of unexcited blue light.

2. The white light emitting device in accordance with claim 1, wherein the red fluorescent powder is europium doped yttrium aluminum garnet (YAG: Eu), and the green fluorescent is europium doped strontium gallium sulfide (SrGa2S4: Eu); and the red fluorescent releases emitted light having a spectrum (wavelength) of 620 nm after being triggered by the blue light source, the green fluorescent releases emitted light having a spectrum (wavelength) of 520 nm, and the spectrum of the blue light emitting light source is between 430 and 480 nm.

3. The white light emitting device in accordance with claim 1, wherein the red fluorescent may be replaced by reddish orange fluorescent made of cerium doped yttrium aluminum (YAG: Ce) having an emitted light spectrum of 590 nm after being triggering by the blue light source.

4. The white light emitting device in accordance with claim 1, wherein the photosemiconductor may be encapsulated and sealed as granule-like structures.

5. The white light emitting device in accordance with claim 1, wherein the photosemiconductor and the fluorescent layer may be filled an paved at an upper breach of a reflecting cover, and an inner walls of the upper breach form light reflecting planes.

6. A white light emitting device comprising:
a photosemiconductor functioning as a light source of blue light; and
the characteristics thereof being that a provided cap cover having a recess at the interior thereof is a formed integral with transparent glue, wherein inner wall surfaces of the recess are applied with a film of fluorescent layer formed by mixing red (or reddish orange) and green fluorescent with the transparent glue, and the cap cover may be accommodated on top of the photosemiconductor.

7. The white light emitting device in accordance with claim 6, wherein the cap cover may be a formed integral from mixing red or reddish orange and green fluorescent with the transparent glue, so as to have the cap cover directly function as a fluorescent layer.
